(19) United States
(12) Patent Application Publication
(10) Pub. No.: US 2017/0066462 A1
(43) Pub. Date: Mar. 9, 2017

(54) Hand Truck With Lift

(71) Applicant: Donald W. Wright, Duncan (CA)

(72) Inventor: Donald W. Wright, Duncan (CA)

(21) Appl. No.: 15/259,905

(22) Filed: Sep. 8, 2016

Related U.S. Application Data
(60) Provisional application No. 62/215,298, filed on Sep. 8, 2015.

(51) Int. Cl. B62B 1/12; B62B 5/08; B62B 5/04

(52) U.S. Cl. CPC B62B 1/125; B62B 5/04; B62B 5/08

(57) ABSTRACT

A hand truck having a powered lift for raising and lowering loads, and including a number of attachments to adapt the hand truck for use in moving carboys, pails and persons.

### CROSS REFERENCE TO RELATED APPLICATIONS

This application claims the benefit of U.S. Application No. 62/215,298, filed 8 Sep. 2015.

### FIELD OF THE INVENTION

The present invention relates to a hand truck (also known as a two wheeler, stack truck, trolley, trundler, box cart, trolley truck, sack barrow, sack truck, dolly, or bag barrowchair) having a powered lift for raising and lowering loads.

### BACKGROUND OF THE INVENTION

A conventional hand truck is an L-shaped box-moving handcart with handles at one end, wheels at the base, with a small ledge to set objects on. The ledge is generally flat against the floor when the hand-truck is upright. The objects to be moved are tilted forward, the ledge is inserted underneath them, and the objects allowed to tilt back and rest on the ledge. Then the truck and object are tilted backward until the weight is balanced over the wheels, making otherwise bulky and heavy objects easier to move.

### SUMMARY OF THE INVENTION

In one aspect, the present invention provides a hand truck for use in transporting, and raising and lowering an item, the hand truck including: a frame having a front and a rear, and defining a linear carriage track and having a bottom pad; a carriage moveably engaged with the frame front and having an item support, a drive assembly for selectively: reversibly linearly moving the carriage along the linear carriage track and releasably fixing the carriage in position along the linear carriage track; and two wheels mounted to the frame; wherein, when the frame is at rest on a horizontal surface, with the bottom pad and wheels in contact with the horizontal surface, a line defined by the linear carriage track is at an angle from the perpendicular of about 1 degrees to about 10 degrees to the frame rear.

The angle may be about 2 degrees to about 6 degrees. More preferably, the angle may be about 4 degrees.

The hand truck may include a support leg pivotally attached to the frame rear and reversibly moveable between: an upper storage position; and a support position in which a distal end of the support leg is proximate to a surface supporting the bottom pad and wheels.

The item support may be a planar platform and the bottom pad may be a plate.

The carriage may include an item retainer assembly including, a manipulable retainer clip for releasably engaging a feature proximate the top of an item; and displacement adjusting means for adjusting the distance between the retainer clip and the planar platform. The retainer clip may be configured to releasably engage an edge lip of a pail lid.

The hand truck may include: a chair assembly attached to the carriage; a brake assembly mounted to the frame, for user controlled braking of the wheels mounted to the frame; and a bottom pad extender for abutting an underlying surface beyond the front extent of the bottom pad; wherein a person with limited mobility may be raised and lowered, and transported using the hand truck.

The chair assembly may include: a seat having a seat bottom, two seat sides and a seat back, wherein the seat sides are hingedly attached to the seat bottom and are hingedly moveable between an upward projecting orientation and substantial planar alignment with the seat bottom; and a swivel configured to permit substantially 180 degrees of rotation of the seat relative to the carriage. The chair assembly may include a swivel lock for releasably fixing the seat in a selected rotational orientation relative to the carriage.

The brake assembly may include a pedal located in the vicinity of the bottom of the frame and configured to apply braking force to the wheels responsive to user foot pressure; a hand brake actuator located in the vicinity of the top of the frame and configured to apply braking force to the wheels responsive to manual pressure; and a park brake actuator located on the frame and configured to stay in a no brake effect orientation or a full brake effect orientation unless moved from one to the other by a user. The wheels may have wheel hubs and the brake assembly may include bands about the wheel hubs whereby braking force to the wheels is applied by tightening the brake bands.

The bottom pad extender may include two extender members, each located along a respective edge of the bottom pad and each having a distal end for abutting the underlying surface beyond the front extent of the bottom pad. Each extender member may have a caster at its distal end and each extender member may be attached to the frame with releasable fasteners.

The item support may be configured to engage and support a vicinity of a pail top; the carriage may include a pail support above the item support, having concave curves sized to receive and steady a pail side; and the bottom pad may include a pail base receiver opening for accepting a pail bottom; wherein, stacked pails comprising a lower pail and one or more upper pails may be moved by aligning the bottom of the lower pail with the pail base receiver opening, engaging the vicinity of the top of the pail top of the lower pail with the item support; and moving the carriage upward.

The bottom pad may be configured as two spaced apart projecting arms, a first projecting arm and a second projecting arm, each projecting arm having a rolling means at its distal end; the item support may include a main ledge having a main ledge top, a front edge, and opposed first and second sides; a first side ledge, having a first side ledge top and being pivotally attached to the first side; a second side ledge having a second side ledge top and being pivotally attached to the second side; wherein, each of the first and second side ledge is free to pivot relative to the main ledge between: an aligned orientation in which the main ledge top and the side ledge top are substantially coplanar; and an angled orientation in which the main ledge top and side ledge top are substantially at a right angle to each other; and wherein, when the carriage is moved towards a lowest position, the first side ledge contacts the first projecting arm and the second side ledge contacts the second projecting arm, whereby contact between the side ledges and the projecting arms causes the side ledges to move towards the angled orientation; and when the carriage is moved upwards from the lowest position the side ledges move towards the aligned orientation under the effect of gravity and as permitted by contact with the projecting arms. The hand truck may include a carboy neck retainer, being a retainer member pivotally attached to the carriage and configured to pivot to a position in engagement with the neck of a carboy so as to impede movement of a carboy located on the item support.

### SUMMARY OF THE DRAWINGS

FIG. 1 is a side elevation view of a general hand truck with lift embodiment of the present invention, shown without the drive assembly.

FIG. 2 is a front elevation view of the general hand truck with lift embodiment, shown without the drive assembly.

FIG. 3 is a side elevation view of the general hand truck with lift embodiment, shown without the drive assembly and including a circle approximating the field of the isolation view shown in of FIG. 4.

FIG. 4 is a side elevation isolation partially transparent view of the general hand truck with lift embodiment, shown without the drive assembly.

FIG. 5 is a rear elevation view of the general hand truck with lift embodiment, shown without the drive assembly and including a circle approximating the field of the isolation view shown in of FIG. 6.

FIG. 6 is a rear elevation isolation partially transparent view of the general hand truck with lift embodiment, shown without the drive assembly.

FIG. 7 is an isometric partially exploded view of a general hand truck with person lift embodiment of the present invention, shown with the seat facing forward.

FIG. 8 is a side elevation view of the general hand truck with person lift embodiment, shown with the seat facing forward.

FIG. 9 is a side elevation view of the general hand truck with person lift embodiment, shown with the seat facing to the side.

FIG. 10 is a top plan view of the general hand truck with person lift embodiment, shown with the seat facing forward and the seat arms in planar alignment with the seat bottom.

FIG. 11 is an isometric view of the seat of the general hand truck with person lift embodiment, shown with the seat sides projecting upwards, with dashed lines indicating the seat arm orientation when in planar alignment with the seat bottom.

FIG. 12 is a front elevation view of the general hand truck with person lift embodiment, shown with the seat facing forward.

FIG. 13 is an isolation front elevation view featuring the seat mount, swivel and swivel lock of the general hand truck with person lift embodiment.

FIG. 14 is a side elevation view of the general hand truck with person lift embodiment shown without dolly wheels.

FIG. 15 is an isometric view of a bottom pad extender of the general hand truck with person lift embodiment.

FIG. 16 is a front elevation view of the general hand truck with person lift embodiment featuring brake components.

FIG. 17 is a rear elevation view of the general hand truck with person lift embodiment, shown without the lift carriage and featuring brake components.

FIG. 18 is a front elevation isolation view of the upper portion of the frame of the general hand truck with person lift embodiment, featuring brake components.

FIG. 19 is a rear elevation isolation view of the lower portion of the frame of the general hand truck with person lift embodiment, featuring brake components.

FIG. 20 is an isometric view of a general hand truck with lift carriage retainer embodiment of the present invention.

FIG. 21 is a side elevation view of the general hand truck with lift carriage retainer embodiment with the retainer bail in an upper position.

FIG. 22 is a front elevation view of the general hand truck with lift carriage retainer embodiment with the retainer bail in an upper position.

FIG. 23 is a rear elevation view of the general hand truck with lift carriage 10 retainer embodiment with the retainer bail in an upper position.

FIG. 24 is a side elevation view of the general hand truck with lift carriage retainer embodiment with the retainer bail in a lower position.

FIG. 25 is a side elevation isolation view of the general hand truck with lift carriage retainer embodiment with the retainer bail in a lower position, showing the bail cross piece and the retainer clip in a disengaged position.

FIG. 26 is a front elevation view of the general hand truck with lift carriage retainer embodiment with the retainer bail in a lower position.

FIG. 27 is a front elevation isolation view of the general hand truck with lift carriage retainer embodiment with the retainer bail in a lower position, showing the bail cross piece and the retainer clip in a disengaged position.

FIG. 28 is an isometric partially exploded view of a pail hand truck embodiment of the present invention.

FIG. 29 is a side elevation view of the pail hand truck embodiment.

FIG. 30 is a front elevation view of the pail hand truck embodiment.

FIG. 31 is a top plan view of the pail hand truck embodiment.

FIG. 32 is an isometric view of a pail carriage of the pail hand truck embodiment having a retainer assembly, shown with the retainer bail in a lower position.

FIG. 33 is an isometric view of the pail carriage of the pail hand truck embodiment having a retainer assembly, shown with the retainer bail in an upper position.

FIG. 34 is an isometric view of a carboy hand truck embodiment of the present invention, shown with the carboy lift carriage in an upper position.

FIG. 35 is an isometric view of the carboy hand truck embodiment, shown with the carboy lift carriage in a lowered position.

FIG. 36 is a side elevation view of the carboy hand truck embodiment, shown with the carboy lift carriage in a lowered position.

FIG. 37 is a front elevation view of the carboy hand truck embodiment, shown with the carboy lift carriage in a lowered position.

### DETAILED DESCRIPTION WITH REFERENCE TO THE DRAWINGS

There are shown in the drawings, embodiments of the present hand truck with lift invention.

The general hand truck with lift embodiment 50 shown in the drawings includes: a frame 52, a lift carriage 54, two dolly wheels 56, a support leg 58 and a drive assembly 60.

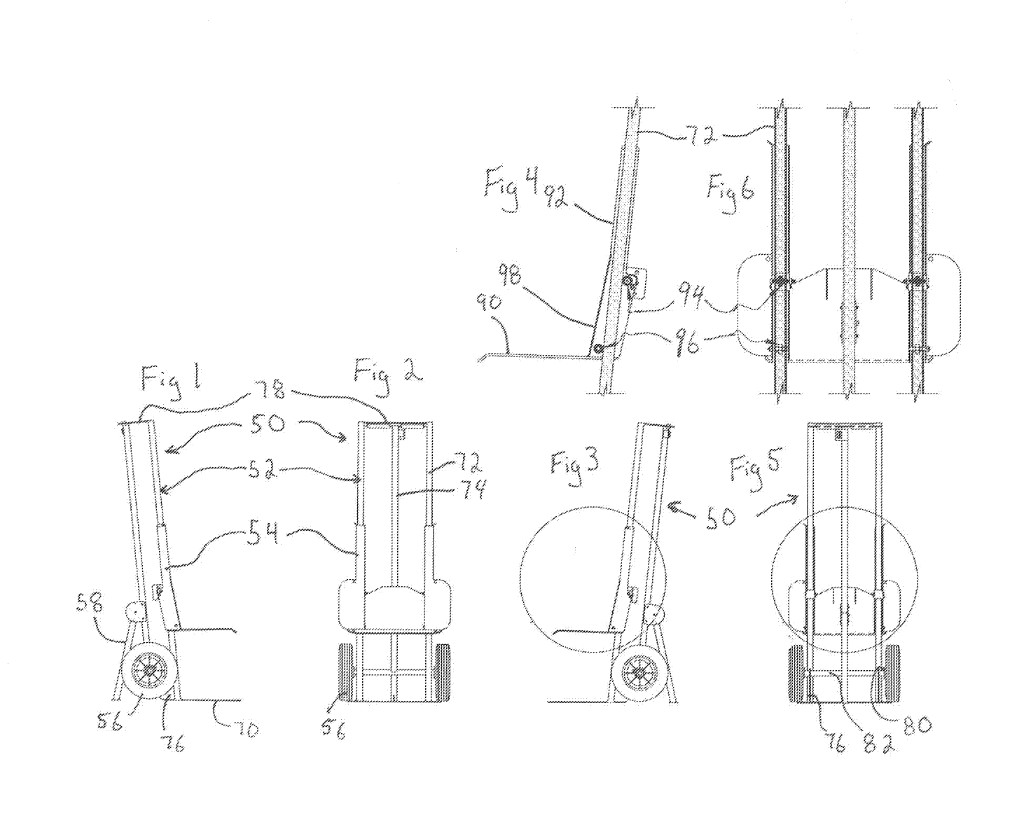

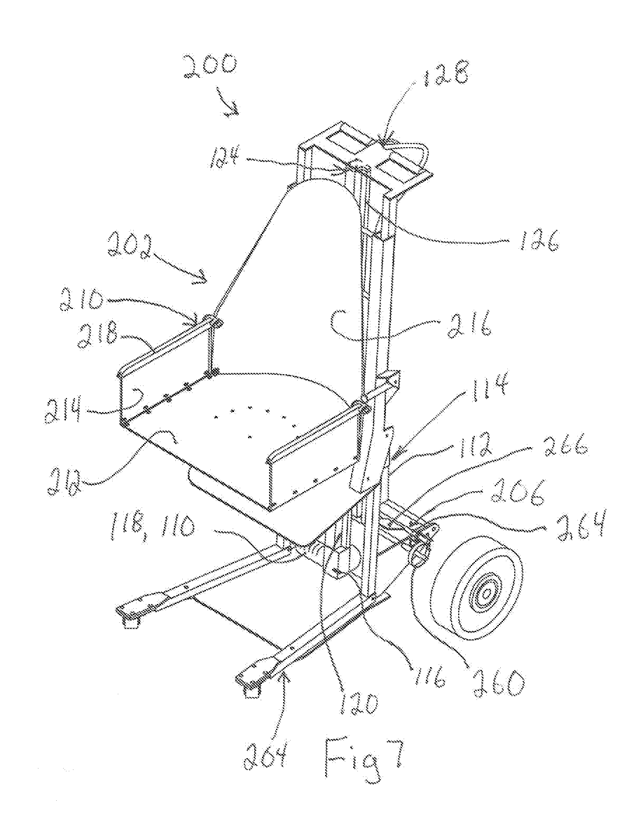

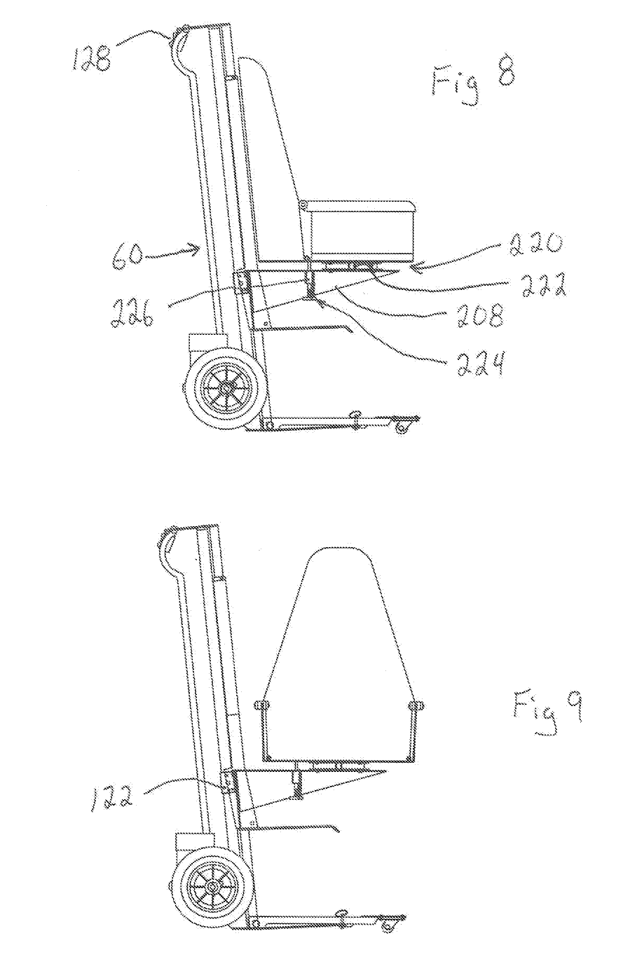

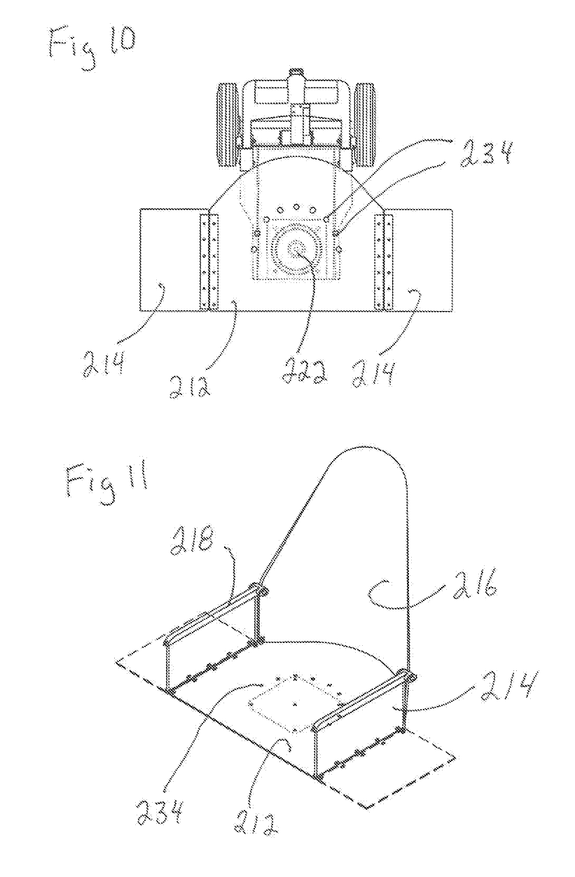

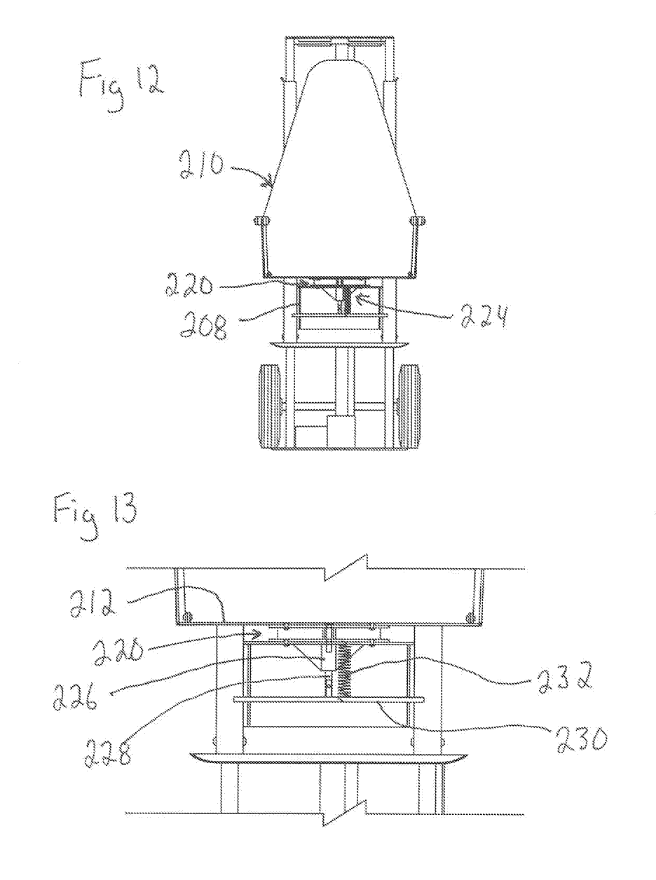

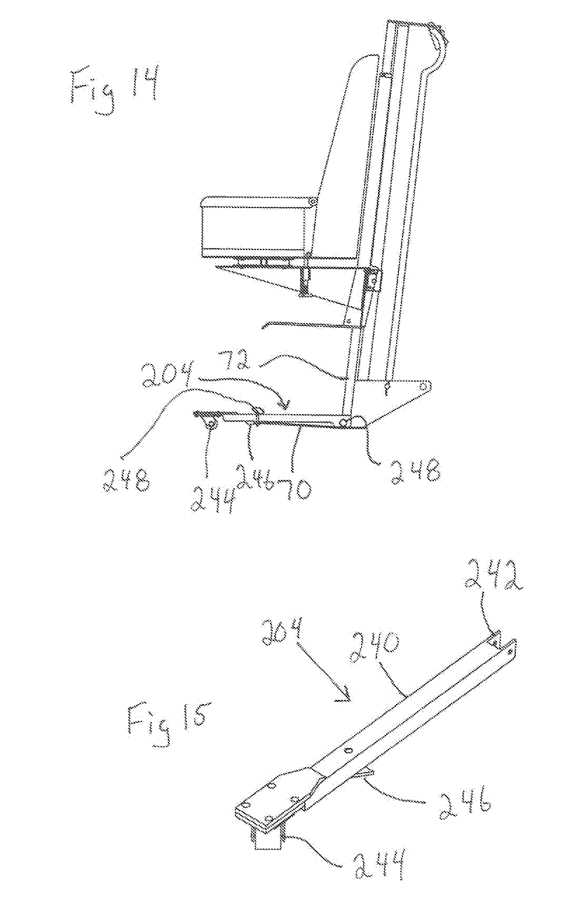

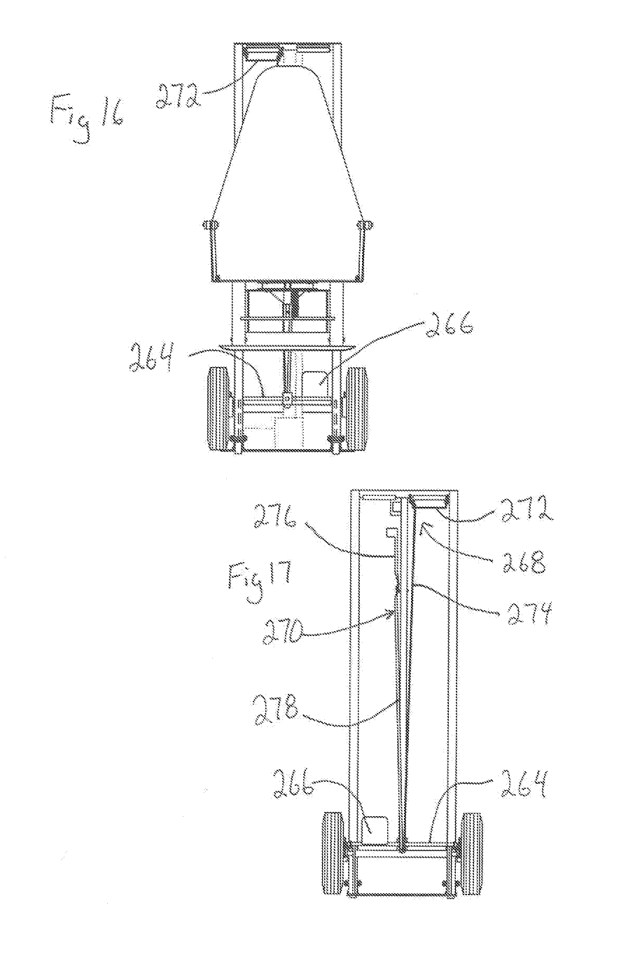

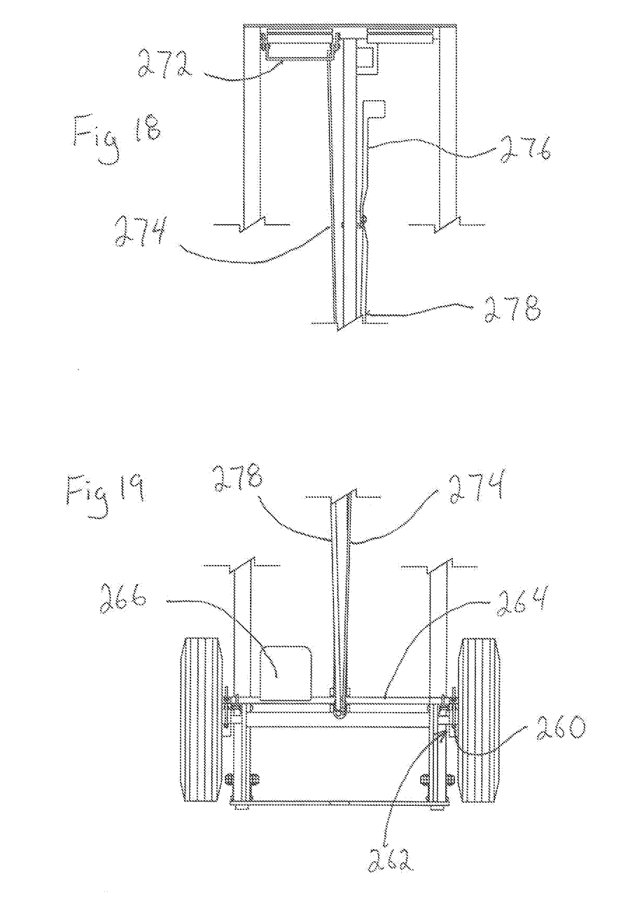

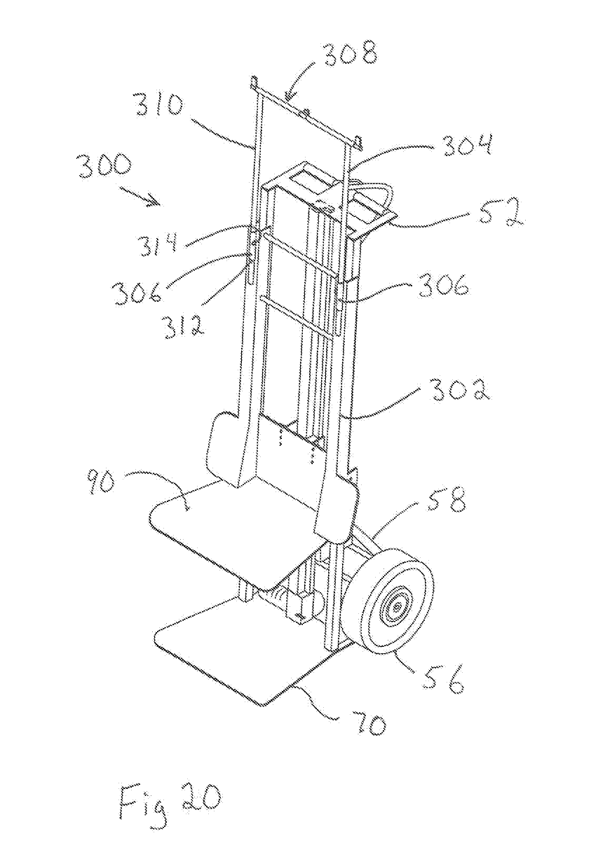

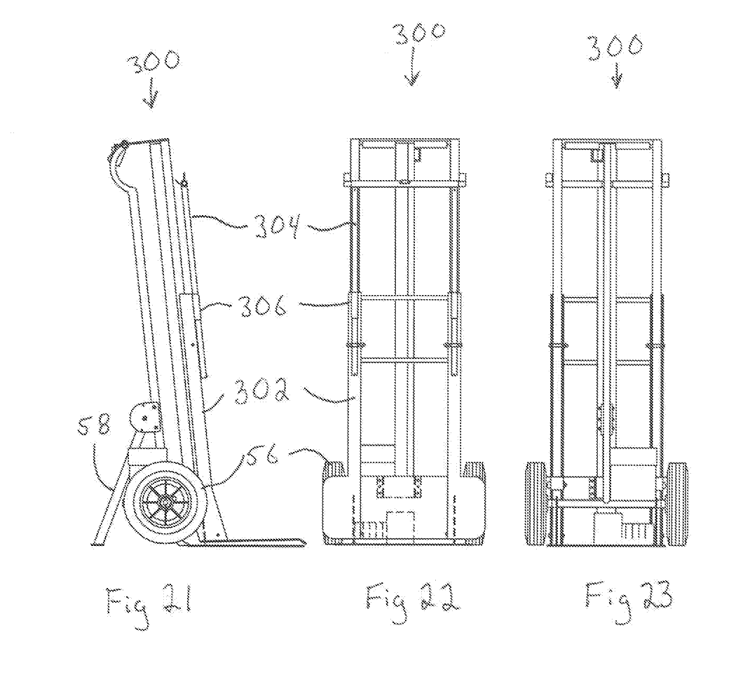

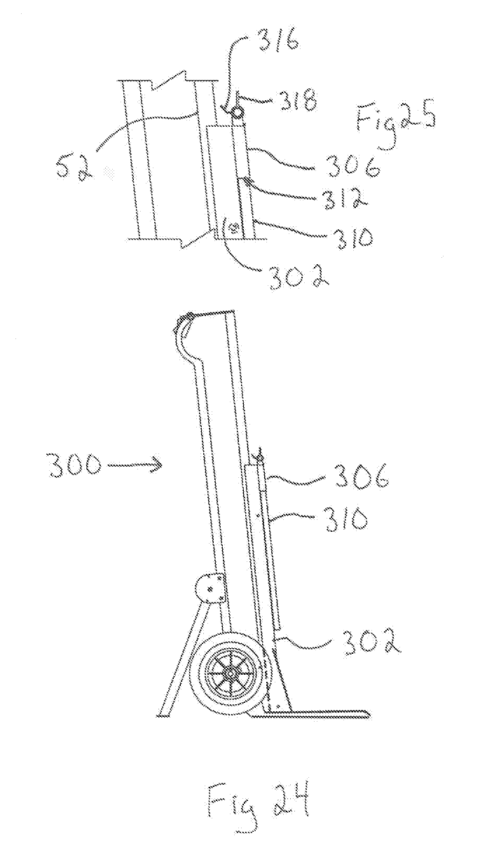

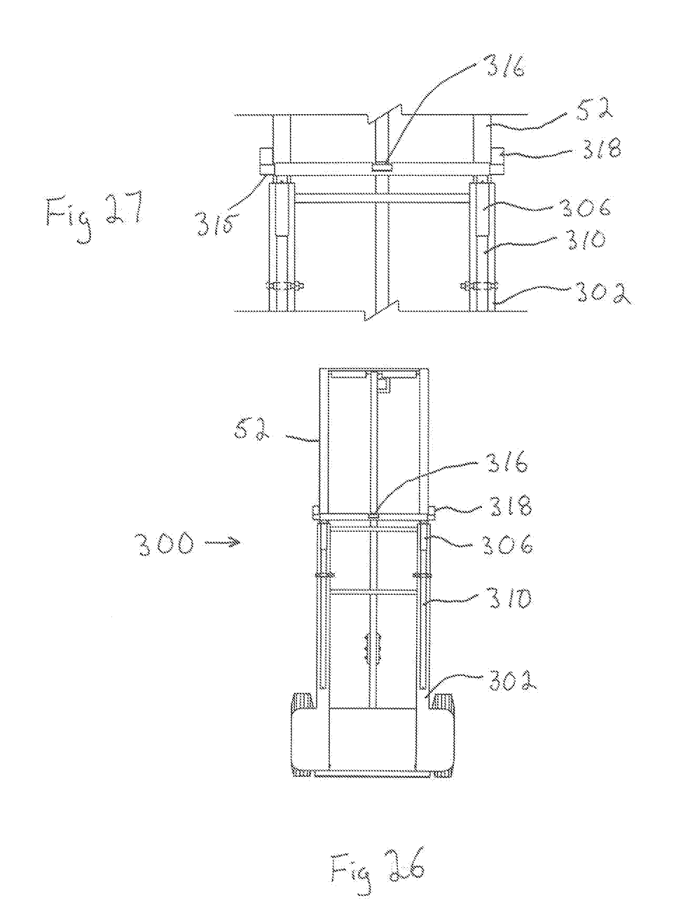

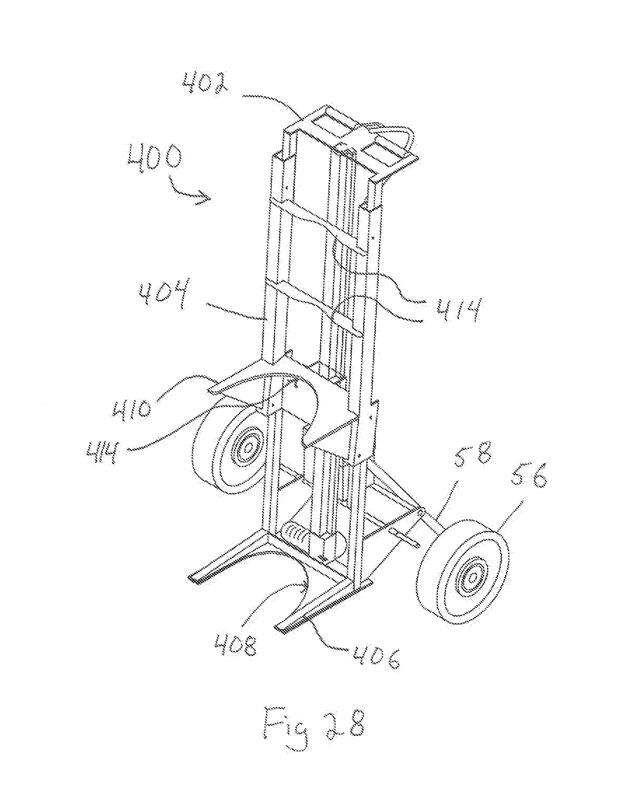

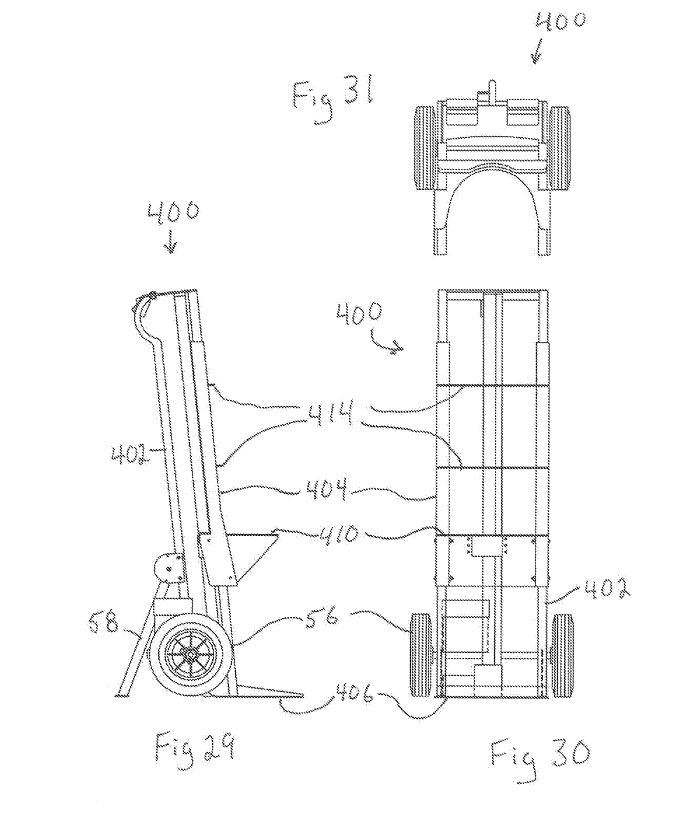

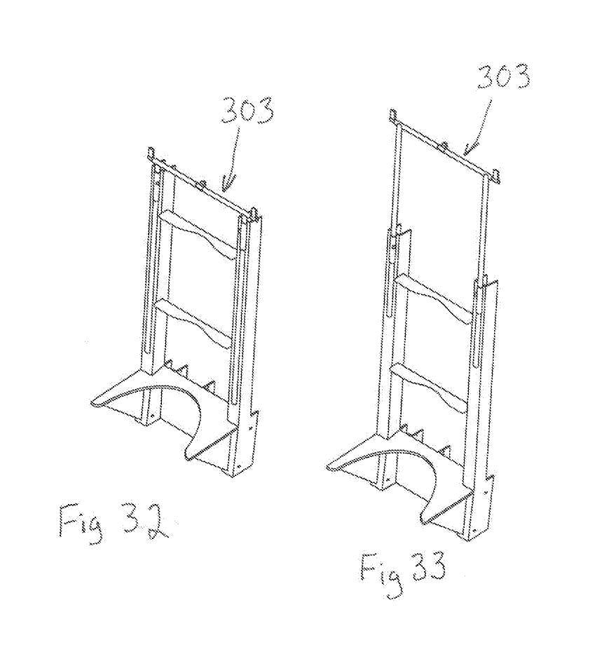

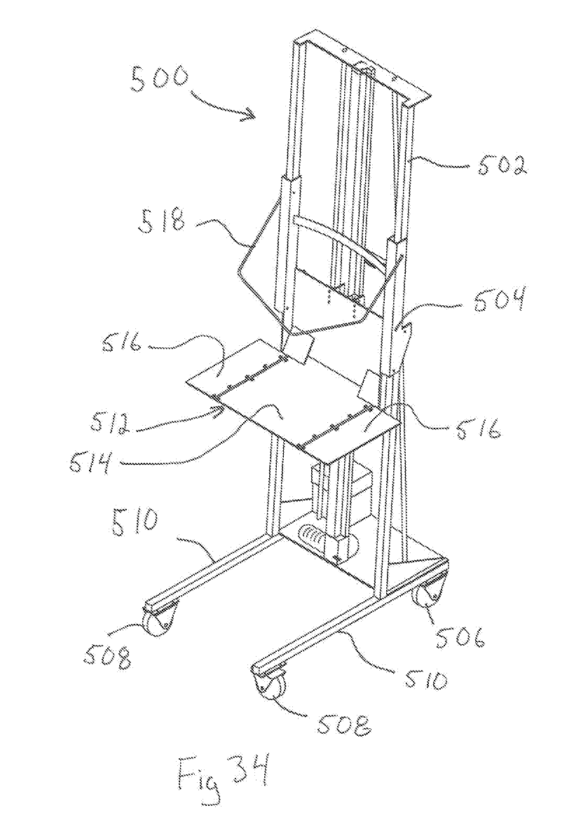

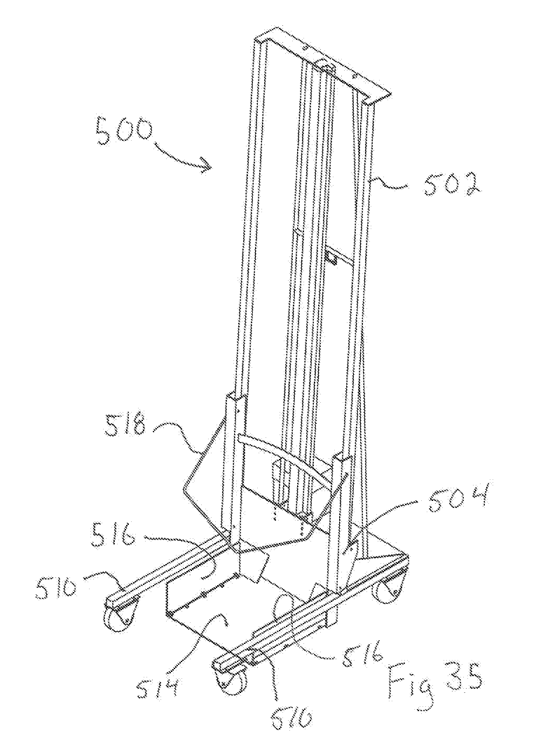

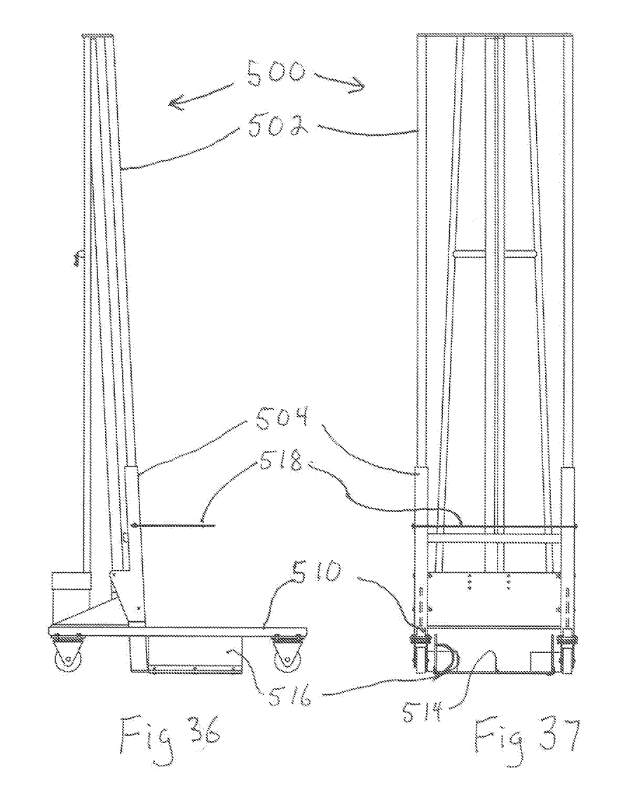

For simplicity, in FIGS. 1 to 6, the general hand truck with lift embodiment 50 is shown without the drive assembly 60.

The frame 52 includes: a bottom pad 70, two spaced apart parallel carriage spars 72, a support strut 74, two brace plates 76 (each brace plate 76 connected to the bottom pad 70 and a respective carriage spar 72), and a handle 78 (spanning and connecting the top ends of the carriage spars 72 and support strut 74).

The brace plates 76 include wheel mounts 80, being holes for receiving the wheel axle 82. The dolly wheels 56 are mounted to the wheel axle 82 adjacent the brace plates 76.

The support leg 58 is pivotally mounted to the support strut 74 so as to be releasably securable in an upper storage position in which the support leg is aligned with, and in close proximity to, the support strut 74; and in a support position in which the support leg 58 projects downward and rearward from the support strut 74 such that the distal end of the support leg 58 (i.e., the lower end when the support leg 58 is in the support position) abuts, or at least is proximate too, a surface that is supporting the general hand truck with lift embodiment 50.

The lift carriage 54 includes: a ledge 90 (which when in a lowered position, overlies the bottom pad 70), two spar engagers 92 (configured, by way of upper roller bearings 94 and lower roller bearings 96, for slidable engagement with the carriage spars 72), a ledge back 98 (connecting, and providing support between, the ledge 90 and spar engagers 92; and providing an abutting surface for items placed on the ledge 90).

As shown in various drawings, the drive assembly 60 includes: an electric motor 110, a battery 112, an AC to DC converter 114, a bevel gear box 116, a motor housing 118, a threaded rod 120, a threaded driven element 122 (attached to the lift carriage 54), an upper bearing 124, a rod housing 126, and a user control 128.

The electric motor 110 is drivably connected to the threaded rod 120 via the bevel gear box 116, which supports the proximal end of the threaded rod 120. The distal end of the threaded rod 120 is supported by the upper bearing 124, which is mounted to the handle 78.

The threaded driven element 122 is attached to the lift carriage 54 such that the threaded driven element 122 is not free to rotate. The threaded driven element 122 includes a threaded bore that is threadedly engaged with the threaded rod 120, such that rotation of the threaded rod 120 causes the threaded driven element 122 to move along the length of the threaded rod 120, which causes the lift carriage 54 to move along the length of the carriage spars 72.

The electric motor 110, battery 112 and AC to DC converter 114 are located within the motor housing 118. The bevel gear box 116 is partially located within the motor housing 118. The electric motor 110 is drivably connect to the bevel gear box 116 such that rotational movement of the electric motor 110 is imparted to the bevel gear box 116 and thus to the threaded rod 120. The drive assembly 60 also includes micro-switches (not shown) for stopping the electric motor 110 when the driven element 122 is at the end of useful travel in either direction. Power for the electric motor 110 is provided by the battery 112 or by the AC to DC converter (when plugged into a conventional electrical outlet). The battery 112 may be charged with a conventional battery charger (not shown). In the preferred embodiment, the battery 112 is a 24 volt battery

Preferably associated with the bevel gear box 116, there is a bevel gear 15 release for use in moving the gears within the bevel gear box 116 between an in-gear position in which the electric motor 110 is drivably connected to the threaded rod 120 and an out-of-gear position in which the electric motor 110 is not drivably connected to the threaded rod 120. In the event of a failure of the electric motor 110 or the battery 112, the bevel gear release may be manipulated to bring the gears into the out-of-gear position and a hand crank be engaged with the top of the threaded rod 120 to manually rotate the threaded rod 120 so as to raise or lower the lift carriage 54.

The screw-drive arrangement of the described embodiment has the advantages of simplicity, robustness and smooth steady movement. As well, in the event that the drive assembly ceases to operate (due to loss of power or component failure), with the screw-drive arrangement, the lift carriage will not drop. However, it will be apparent that other lifting means, for example rams (hydraulic or air), or cable-pulley assemblies or chain-gear assemblies, could also be used. However, as compared to other lifting means, for example a ram, the screw-drive arrangement provides a full range of movement without an associated upward projecting component. Such an associated upward projecting component may be problematic in locations with limited vertical clearance.

The user control 218 controls the electric motor 110. The user control 218 is mounted at the handle 78 and has three positions, “up”, “stop” and “down”, with “stop” being the default position when neither “up” nor “down” is engaged. Locating the user control 218 on the handle 78 (i.e., at the top of the general hand truck with lift embodiment) ensures that one of the user's hands is on the handle 78 when the lift carriage 54 is being raised or lowered. Having at least one of the user's hands at the handle 78 is desirable, particularly when a load is being raised, in that this is the optimum hand position for both sensing and reacting to instability of the general hand truck with lift embodiment 50 and load.

As indicated in the drawings, the general hand truck with lift embodiment 50 is configured such that the angle between the bottom pad 70 and the carriage spars 72 is greater than 90 degrees, such that as a load supported by the ledge 90 is raised, the center of gravity of the load moves rearward, so as to be supported by both the bottom pad 70 and the dolly wheels 56 (and the support leg 58 if moved to the support position by the user). In the embodiment shown in the drawings the angle between the bottom pad 70 and the carriage spars 72 is about 96 degrees. This angle, along with the relative proportions of the bottom pad 70 and the carriage spars 72, and the position of the dolly wheels 56 relative to the top of the carriage spars 72 (as indicated in the drawings) has been found to provide sufficient stability during raising and lowering for a variety of items suitable for moving with a hand truck (i.e., items that can be supported with stability on the ledge).

Embodiments of the present invention are preferably made from aluminum so as to minimize weight, but could be made from other metals or metals and other materials (e.g., high-strength composites). The use of light material coupled with the relatively small size and narrow lateral profile of the hand truck embodiments described and shown herein makes possible use of the embodiments within the home. The general hand truck with lift embodiment 50 may be about 50 inches tall and weigh about 55 pounds.

The lift carriage 54 preferably includes holes or other features suitable for affixing a line, tarp strap etc. to the lift carriage 54 for use in securing a load on the ledge 90. To assist in maintaining loads on the ledge 90, the ledge 90 preferably includes a non-skid surface.

A general hand truck with person lift embodiment 200, includes a chair assembly 202, two bottom pad extenders 204 and a brake assembly 206. The general hand truck with person lift embodiment 200 is intended for use with individuals with limited mobility (for example paraplegics).

The chair assembly 202 includes a seat mount 208 (in use, attached to the lift carriage 54, preferably by nuts and bolts); a seat 210 (comprising a seat bottom 212, two seat sides 214 hingedly attached to the seat bottom so as to be free to move about 90 degrees between planar alignment with the seat bottom 212 and an upward projection orientation, a seat back 216 pivotally attached to the seat bottom 212, and two seat armrests 218 pivotally connected to the seat back 216 and pivotal between a seat side engagement orientation in which the each seat armrest 218 engages and releasable secures an edge of a respect seat side 214 and an upper armrest orientation in which the seat armrest 218 is disengaged from the respective seat side 214); and a swivel assembly 220 interposed between the seat mount 208 and the seat 210.

The swivel assembly 220 includes a swivel 222 configured to permit 180 degree rotation of the seat 210 relative to the seat mount 208 (i.e., from one side to the other side) and a swivel lock 224 configured to releasably secure the seat 210 in a plurality of selected rotational orientations of the seat 210 relative to the seat mount 208. In the embodiment shown in the drawings, the selected rotational orientations are 22.5 degrees apart.

The swivel lock 224 comprises a lock bore 226 (being a bore through the seat mount 208), a lock pin 228 (extending through the lock bore 226), a lock latch 230 (as indicated in the drawings, the lock pin 228 and lock latch 230 may be a functionally unitary generally T-shaped component); a lock spring 232 (under tension between the lock latch 230 and the seat mount 208), and a plurality of lock pin receptacles 234 in the seat bottom 212 (as indicated in the drawings the lock pin receptacles 234 may be holes through the seat bottom 212; alternatively, the lock pin receptacles 234 may be concavities in the seat bottom 212). In use, the lock spring holds the lock pin 228 in engagement with one of the lock pin receptacles 234 to maintain a desired rotational orientation of the seat 210 relative to the seat mount 208. To rotate the seat 210 to another rotational orientation, the user moves the lock latch 230 away from the seat 210, so as to disengage the lock pin 228 from the relevant lock pin receptacle 234, then rotates the seat to a new desired orientation and engages the lock pin 228 with the lock pin receptacle associated with the new desired orientation.

Each bottom pad extender 204 comprises: an extender member 240; a carriage spar connector 242 at a proximal end of the extender member 240; an extender caster 244 at a distal end of the extender member 240; a pad edge engager 246 intermediate the proximal and distal ends of the extender member 240; and two extender member fasteners 248 (being quick release pins in the embodiment shown in the drawings). The pad edge engager 246 includes: a proximally projecting clip with a portion spaced apart sufficiently from the extender member 240 to receive an edge of the bottom pad 70; and aligned holes through the extender member 240 and the edge of the bottom pad 70 configured to securely retain an extender member fastener 248. The carriage spar connector 242 comprises two spaced apart tangs with holes aligned with holes near the bottom of the respective carriage spar 72, the aligned holes configured to securely retain an extender member fastener 248. In use, each bottom pad extender 204 is attached along a respective side of the bottom pad 70.

The brake assembly 206 includes two brake bands 260 (each positioned around a respect wheel hub 262), a brake shaft 264 extending between and connected to the brake bands 260 such that rotation of the brake shaft 264 tightens or loosens the brake bands 260 depending on the direction of rotation; a brake pedal 266 (being a foot operable pedal mounted to the brake shaft 264); a handle brake assembly 268; and a park brake assembly 270. The handle brake assembly 268 includes a handle brake actuator 272 and a handle brake rod 274 extending between the handle brake actuator 272 and the brake shaft 264, whereby the handle brake actuator 272 may be manipulated to rotate the brake shaft 264. The brake pedal 266 and handle brake assembly 268 function like the brake pedal in a vehicle in that the braking effect ceases once the users ceases operating the brake. The park brake assembly 270 includes a park brake lever 276 and a park brake rod 278 extending between the park brake lever 276 and the brake shaft 264, whereby movement of the park brake lever 276 causes rotation of the brake shaft 264. The park brake assembly 270 functions like the park brake in a vehicle in that braking effect continues until the user releases the brake.

The general hand truck with person lift embodiment 200 includes two handholds 280 pivotally mounted to the sides of the lift carriage 54.

The general hand truck with person lift embodiment 200 permits an operator to assist a person with limited mobility in moving both horizontally and vertically. The swivel assembly 220 and hinged seat sides 214 facilitate shifting a person off or on the seat 210 to and from locations in a multitude of heights and orientations, in that persons with limited mobility but with some upper body strength tend to move sideways and the seat 210 may be readily oriented to permit such sideways movement and the handholds 280 are of use with such movement.

The chair 142 is mounted to the chair bracket 146 via the swivel 144. The chair 142 and chair bracket 146 include releasably engageable features (e.g., the swivel lock indicated in the drawings) so as to permit the user to releasably secure the chair in at least a front facing orientations and preferably in additional orientations (e.g., turned 90 degrees either way from the front orientation and possibly intermediate orientations between the front orientation and the 90 degrees turned orientations).

The chair 142 includes a seat 148, a seat back 150 and seat sides 152, each seat side 152 including an arm rest 154. As indicated in the drawings, parts of the chair 142 are hingedly attached to adjacent parts: to make the chair foldable when not in use (e.g. the seat back 150 may be hinged down to overlay the seat 148); and to facilitate moving a person on and off the seat 148 (e.g., a seat side 152 may be hinged down so as to provide a ramp for sliding a person on or off the seat 148).

A general hand truck with retainer lift carriage embodiment 300 includes a frame 52, a retainer lift carriage 302, two dolly wheels 56, a support leg 58 and a drive assembly 60.

The retainer lift carriage 302 includes a retainer assembly 303 comprising a retainer bail 304 and two bail mounts 306. The retainer bail 304 includes a bail cross piece 308 and two bail legs 310. Each bail leg 310 extends through a leg bore 312 in an associated bail mount 306. Each bail mount 306 includes a set screw 314 for fixing the bail leg 310 within the leg bore 312.

The retainer cross piece 308 includes a rotatable retainer shaft 315 having a retainer clip 316 in the middle and a retainer tang 318 at each end. In use, the retainer mounts 306 are used to position the retainer cross piece 308 at a desired location with respect to the top lip of a pail in a stack of pails to be transported with the general hand truck with lift carriage retainer embodiment 300. Once the stack of pails is engaged, the user manipulates one or the other of the retainer tangs 318 so as to rotate the retainer clip 316 into engagement with the top lip of the pail, thus steadying the stack of pails. In many settings, there will be a standardized pail size such that once the retainer cross piece 308 is positioned at a location, it may not be necessary to change the location or may only be rarely necessary to do so.

A pail hand truck embodiment 400 is configured for use with 5-gallon (about 20 liters) pails (not shown). The pail hand truck embodiment 400 includes a pail frame 402, a pail carriage 404, two dolly wheels 56, a support leg 58 and a drive assembly 60. The pail frame 402 has a pail bottom pad 406 having a pail base receiver 408 sized to accommodate the bottom of a 5-gallon pail. The pail carriage 404 has pail ledge 410 having a pail top lip receiver 412, configured to engage the top lip of a 5-gallon pail, and pail supports 414, being horizontally extending members with concave curves sized to receive and steady the abutting side of a 5-gallon pail.

In use, the pail hand truck embodiment 400 may be used to move a stack of 5-gallon pails (e.g., three stacked 5-gallon pails), by engaging the top lip of the lowest of the stacked 5-gallon pails with the pail top lip receiver 412, raising the pail carriage 404 sufficiently to lift the stacked 5-gallon pails from the underlying surface, and tilting the pail hand truck embodiment 400 sufficiently to bring the side of each of the upper stacked 5-gallon pails into steadying engagement with an adjacent pail support 414.

A carboy hand truck embodiment 500 is intended for use with a carboy (not shown; also referred to as a demijohn, or jimmyjohn), which is a rigid container, typically with a capacity in the range of 5 to 15 gallons (about 20 to 60 liters) and having a large body and a small neck. Carboys are generally in used in small-scale fermentation of beverages, often beer or wine, by individuals in home or at the premises of businesses providing services to individuals making beer or wine. Such businesses typically store (on racks or shelves) numerous carboys for numerous individuals, who periodically inspect the fermenting liquids and takes steps related to the fermentation process. Thus, in such businesses, it is necessary to move carboys to and from storage areas (e.g., shelves), and areas suitable for inspection and processing and/or loading areas for transport away from the business premises.

The carboy hand truck embodiment 500 includes a carboy frame 502, a carboy lift carriage 504, two carboy wheels 506, two carboy caster wheels 508 and a drive assembly 60.

The carboy frame 502 includes two projecting carboy arms 510. A carboy caster wheel 508 is mounted at the distal end of each carboy arm 510. The carboy wheels 506 are mounted at the rear of the carboy frame 502, i.e. opposite the carboy caster wheels 508.

The carboy lift carriage 504 includes a carboy ledge 512. The carboy ledge 512 includes a carboy main ledge 514 and two carboy side ledges 516. Each carboy side ledge 516 is pivotally attached to a respective side of the carboy main ledge 514, wherein the pivotal attachment is configured such that each carboy side ledge 516 is free to pivot relative to carboy main ledge 514 between: an aligned orientation (i.e., in 15 which the carboy main ledge 514 and carboy side ledge 516 are in planar alignment in that both extending substantially horizontally): and an angled orientation (i.e., in which the carboy side ledge 516 projects substantially vertically).

In use, when the carboy lift carriage 504 is moved to the lowest position, each carboy side ledge 516 contacts a respective carboy arm 510, causing the carboy side ledges 516 to pivot from the aligned orientation toward the angled orientation. When the carboy lift carriage 504 is moved upwards from the lowest position, subject to contact with the carboy arms 510, the carboy side ledges 516 move towards the aligned orientation under the effect of gravity.

A carboy may be manually shifted by grasping the neck and dragging the carboy or by edge rolling the carboy (i.e., by tilting the carboy slightly and rotating the carboy so as to roll along the bottom edge of the carboy contacting the supporting surface).

With the carboy ledge 512 in the lowest position, the angled orientation of the carboy side ledges 516 permits a carboy to be manually shifted on or off the carboy main ledge 514 only in a direction between the carboy arms 510. With the carboy side ledges 516 in the aligned orientation, a carboy may be manually shifted on or off the carboy ledge 512 directly on or off the carboy main ledge 514 or via either carboy side ledge 516, thus permitting carboys to be moved on or off a shelve where it is not possible to bring the carboy main ledge 514 directly adjacent the shelve.

Embodiments of the present invention may include shields (not shown in the drawings), preferably transparent plastic, to protect the user when the hand truck is used with pails, carboys or other containers of liquid.

The scope of the claims should not be limited by the preferred embodiments set forth in the examples, but should be given the broadest interpretation consistent with the description as a whole.

What is claimed is:

1. A hand truck for use in transporting, and raising and lowering an item, the hand truck comprising:
a frame having a front and a rear, and defining a linear carriage track and having a bottom pad;
a carriage moveably engaged with the frame front and having an item support,
a drive assembly for selectively: reversibly linearly moving the carriage along the linear carriage track and releasably fixing the carriage in position along the linear carriage track; and
two wheels mounted to the frame;
wherein, when the frame is at rest on a horizontal surface, with the bottom pad and wheels in contact with the horizontal surface, a line defined by the linear carriage track is at an angle from the perpendicular of about 1 degrees to about 10 degrees to the frame rear.

2. The hand truck of claim 1, wherein the angle is between 2 degrees to about 6 degrees.

3. The hand truck of claim 2, wherein the angle is about 4 degrees.

4. The hand truck of claim 1, further comprising a support leg pivotally attached to the frame rear and reversibly moveable between: an upper storage position; and a support position in which a distal end of the support leg is proximate to a surface supporting the bottom pad and wheels.

5. The hand truck of claim 1, wherein the item support is a planar platform and the bottom pad is a plate.

6. The hand truck of claim 5, wherein the carriage comprises an item retainer assembly comprising, a manipulable retainer clip for releasably engaging a feature proximate the top of an item; and displacement adjusting means for adjusting the distance between the retainer clip and the planar platform.

7. The hand truck of claim 6, wherein the retainer clip is configured to releasably engage an edge lip of a pail lid.

8. The hand truck of claim 1, further comprising:
a chair assembly attached to the carriage;
a brake assembly mounted to the frame, for user controlled braking of the wheels mounted to the frame; and
a bottom pad extender for abutting an underlying surface beyond the front extent of the bottom pad;
wherein a person with limited mobility may be raised and lowered, and transported using the hand truck.

9. The hand truck of claim 8, wherein the chair assembly comprises:
a seat having a seat bottom, two seat sides and a seat back, wherein the seat sides are hingedly attached to the seat bottom and are hingedly moveable between an upward projecting orientation and substantial planar alignment with the seat bottom; and
a swivel configured to permit substantially 180 degrees of rotation of the seat relative to the carriage.

10. The hand truck of claim 9, wherein the chair assembly further comprises a swivel lock for releasably fixing the seat in a selected rotational orientation relative to the carriage.

11. The hand truck of claim 8, wherein the brake assembly comprises:
a pedal located in the vicinity of the bottom of the frame and configured to apply braking force to the wheels responsive to user foot pressure;
a hand brake actuator located in the vicinity of the top of the frame and configured to apply braking force to the wheels responsive to manual pressure; and
a park brake actuator located on the frame and configured to stay in a no brake effect orientation or a full brake effect orientation unless moved from one to the other by a user.

12. The hand truck of claim 11, wherein the wheels have wheel hubs and the brake assembly includes bands about the wheel hubs whereby braking force to the wheels is applied by tightening the brake bands.

13. The hand truck of claim 8, wherein the bottom pad extender comprises two extender members, each located along a respective edge of the bottom pad and each having a distal end for abutting the underlying surface beyond the front extent of the bottom pad.

14. The hand truck of claim 13, wherein each extender member has a caster at its distal end and each extender member is attached to the frame with releasable fasteners.

15. The hand truck of claim 1, wherein:
the item support is configured to engage and support a vicinity of a pail top;
the carriage includes a pail support above the item support, having concave curves sized to receive and steady a pail side; and
the bottom pad includes a pail base receiver opening for accepting a pail bottom;
wherein, stacked pails comprising a lower pail and one or more upper pails may be moved by aligning the bottom of the lower pail with the pail base receiver opening, engaging the vicinity of the top of the pail top of the lower pail with the item support; and moving the carriage upward.

16. The hand truck of claim 1 wherein,
the bottom pad comprises two spaced apart projecting arms, a first projecting arm and a second projecting arm, each projecting arm having a rolling means at its distal end,
the item support comprises
a main ledge having a main ledge top, a front edge, and opposed first and second sides;
a first side ledge, having a first side ledge top and being pivotally attached to the first side;
a second side ledge having a second side ledge top and being pivotally attached to the second side;
wherein, each of the first and second side ledge is free to pivot relative to the main ledge between:
an aligned orientation in which the main ledge top and the side ledge top are substantially coplanar; and
an angled orientation in which the main ledge top and side ledge top are substantially at a right angle to each other; and
wherein,
when the carriage is moved towards a lowest position, the first side ledge contacts the first projecting arm and the second side ledge contacts the second projecting arm, whereby contact between the side ledges and the projecting arms causes the side ledges to move towards the angled orientation; and
when the carriage is moved upwards from the lowest position the side ledges move towards the aligned orientation under the effect of gravity and as permitted by contact with the projecting arms.

17. The hand truck of claim 16 further comprising a carboy neck retainer, being a retainer member pivotally attached to the carriage and configured to pivot to a position in engagement with the neck of a carboy so as to impede movement of a carboy located on the item support.
